(19) United States
(12) Patent Application Publication
(10) Pub. No.: US 2022/0169760 A1
(43) Pub. Date: Jun. 2, 2022

(54) SEMI-CRYSTALLINE SILYL ETHER BASED VITRIMERS, METHODS OF MAKING AND USES THEREOF

(71) Applicant: SABIC Global Technologies B.V., Bergen op Zoom (NL)

(72) Inventors: Jérôme VACHON, Geleen (NL); Arkadiusz ZYCH, Parma (IT); Maria SOLIMAN, Geleen (NL); Roberta PINALLI, Parma (IT); Enrico DALCANALE, Parma (IT)

(73) Assignee: SABIC Global Technologies B.V., Bergen op Zoom (NL)

(21) Appl. No.: 17/594,138

(22) PCT Filed: Apr. 2, 2020
(86) PCT No.: PCT/IB2020/053157

§ 371 Date: Oct. 4, 2021

Related U.S. Application Data
(60) Provisional application No. 62/829,939, filed on Apr. 5, 2019.

(51) Int. Cl. C08F 210/02

(52) U.S. Cl. CPC C08F 210/02; C08F 2800/10; C08F 2810/50; C08F 2810/20

(57) ABSTRACT

Semi-crystalline vitrimers that include a silyl ether functionality are described. Methods of making and uses thereof are also described.

### CROSS-REFERENCE TO RELATED APPLICATIONS

This application claims the benefit of priority of U.S. Provisional Patent Application No. 62/829,939 filed Apr. 5, 2019, which is hereby incorporated by reference in its entirety.

### GOVERNMENT STATEMENT

The invention was made with support from the European Union's Horizon 2020 research and innovation program under the Marie Sklodowska-Curie grant agreement No. 642929.

### BACKGROUND OF THE INVENTION

### A. Field of the Invention

The invention generally concerns vitrimer polymers, methods of producing vitrimer polymers, and uses thereof. In particular, the vitrimer polymers have a semi-crystalline morphology and include a silyl ether linkage between two polymer units (e.g., polyolefin units, polycarbonate-based units, or a polyester-based units, or combinations thereof).

### B. Description of Related Art

Vitrimers are an emerging class of polymers that have properties of permanently cross-linked thermosets while at the same time retaining processability due to covalent adaptable networks (CAN). CAN, when thermally triggered, can undergo exchange reactions of cross-links, which facilitate polymer network rearrangement, making macroscopic reshaping possible. If a stress is applied to the system, the networks can rearrange until the stress relaxes and a new shape is obtained. The relaxation process can be controlled by the reaction kinetics, and, consequently, the viscosity in the melt decreases following the Arrhenius law. This characteristic is distinctly different from conventional polymers such as polystyrene, which exhibits a viscosity drop abruptly after reaching its glass transition (Tg).

Various attempts to produce vitrimers have been described. By way of example, Denissen et al. (Advanced Functional Materials 25.16 (2015): 2451-2457 and Nature communications 8 (2017): 14857) described catalyst free vitrimers that include vinylogous urethane cross-links. In another example, Zhou et al. (Macromolecules 50.17 (2017): 6742-6751) and Demongeot et al. (Macromolecules 50.16 (2017): 6117-6127) each describe poly(butylene terephthalate)-based vitrimers. In yet another example, de Luzuriaga et al. (Journal of Materials Chemistry C 4.26 (2016): 6220-6223) and Azcune et al. (European Polymer Journal 84 (2016): 147-160) describe epoxide type vitrimers. In still another example, U.S. Patent Application Publication No. 2017327625 to Du Prez et al. describes vitrimers that include urethane cross-link functionality. Fully amorphous styrene based silyl ether linked styrene vitrimers are described by Nishimura et al. (Journal of the American Chemical Society, 2017, 139, 14881-14884), which require a prolonged period of time to produce (e.g., 6 hours under compression-mold).

While various vitrimers have been described, many of them require catalysts, solvents, prolonged processing time, and/or the resulting vitrimer is susceptible to hydrolysis and aging.

### SUMMARY OF THE INVENTION

A discovery has been made that address at least some of the problems associated with vitrimer polymers and producing such polymers. The solution is premised on producing a semi-crystalline silyl ether linked polymeric matrix using reactive extrusion methodology. Such methodology provides a solution to solvent based catalyst cross-linking methodology, which can cause side reactions like chain scission and permanent crosslinking, which can significantly alter the polymer mechanical properties. Furthermore, reactive extrusion allows fine tuning of crosslink density, which facilitates production of molded products (e.g., compression molding time and/or injection molding) with the desired end properties. The silyl ether can be extruded with a functionalized polymer to produce a vitrimer polymer composition. Notably, the vitrimer material of the present invention can have a semi-crystalline morphology, which can impart increased strength to the material due to the presence of crystal domains. The combination of the presence of the crystal domains and the cross-linked vitrimer network can result in relatively strong polymeric materials. Further, and despite the cross-linking, the vitrimer material of the present invention can be recyclable. Still further, while preferred aspects of the present invention relate to semi-crystalline polyolefin-based vitrimers, the vitrimer materials of the present invention have wider applications for non-polyolefin based vitrimers.

In a particular aspect of the invention, semi-crystalline vitrimer polymer compositions are described. A semi-crystalline vitrimer polymer composition can include a silyl ether having the following structure.

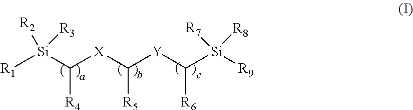

where: R₁ and R₉ can each be independently a hydroxyl-functionalized polymeric group; R₂, R₃, R₇, and R₈ can each be independently a hydroxyl-functionalized polymeric group, an aliphatic group, a hydroxy group (OH), or an alkoxy group; R₄, R₅, and R₆ can each be independently H or an aliphatic group; X and Y can each be independently NH, O, S, or CH₂; and a can be 1 to 10, b can be 1 to 10, and c can be 1 to 10. R₁, R₂, R₃, R₇, R₈ and R₉ can each be independently a polyolefin-based polymeric group, a polycarbonate-based polymer group, or a polyester-based polymeric group, or any combination thereof that include one or more hydroxy groups. In certain aspects, the semi-crystalline vitrimer polymer composition can have a degree of crystallinity of at least 5%, at least 6%, at least 7%, at least 8%, at least 9%, at least 10%, at least 15%, at least 20%, at least 30%, at least 40% at least 50%, at least 60%, at least 70%, at least 80%, at least 90% or more. In some preferred aspects, the degree of crystallinity of the vitrimer composition is 5% to 50%, 7% to 50%, 9% to 50%, 10% to 50%, 5% to 40%, or any range or number within 5% and 50% (e.g., 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49%). In some more preferred aspects, the degree of crystallinity is 7% to 50%, 7% to 40%, 7% to 15%, 10% to 13%, or 10.5% to 12.5%. In still another aspect of the present invention, and referring to the above structure, when X and Y are both NH, R₁ and R₉ are not a styrene hydroxyl-functionalized based polymeric groups. In a preferred embodiment, the vitrimer polymer composition is a hydroxyl-functionalized polyolefin-based polymer. In some aspects, R₁ and R₉, preferably R₁, R₂, R₃, R₇, R₈ and R₉, can each be

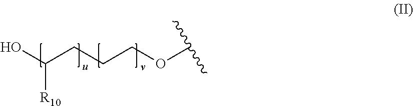

where R₁₀ can be H or an alkyl, u can be 0 to 1, v can be 0 to 1, wherein u+v=1, and u and v can be randomly distributed. In terms of mole percent (mol. %), u can range from 0 to 100 mol. %, v can range from 0 to 100 mol. %, wherein the total mol. % of u+v=100 mol. %. In another aspect of the present invention, R₁ and R₉, preferably R₁, R₂, R₃, R₇, R₈ and R₉, can each be:

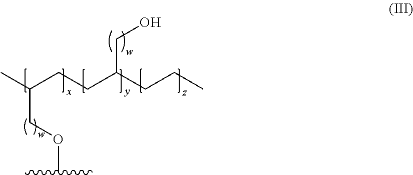

where y can be >0, x+y=0.01 to 0.2, z can be 0.8 to 0.99, wherein x+y+z=1 and w can be 0 to 20, and the monomer units corresponding to x, y, and z can be randomly distributed, where w is repeat units, and x, y, z are mole fractions. In terms of mole percent (mol. %), y can be >0, x+y can range from 1 to 20 mol. %, z can range from 80 to 99 mol. %, wherein the total mol. % of x+y+z=100 mol. %. In yet another aspect of the present invention, R₁ and R₉, preferably R₁, R₂, R₃, R₇, R₈ and R₉, can each be

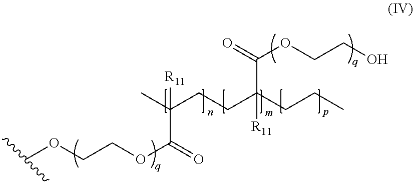

where R₁₁ can be H or an alkyl group, q can be 1 to 10, m can be >0, n+m=0.01 to 0.2, p can be 0.8 to 0.99, wherein n+m+p=1 and the monomer units corresponding to n, m, andp can be randomly distributed, where q is repeat units, and n, m, p are mole fractions. In terms of mole percent (mol. %), m can be >0, n+m can range from 1 to 20 mol. %, p can range from 80 to 99 mol. %, wherein the total mol. % of n+m+p=100 mol. %. In a preferred aspect, X and Y can be NH, a and c can be 2 to 4, b can be 1 to 3, and R₁, R₂, R₃, R₇, R₈ and R₉ can each be

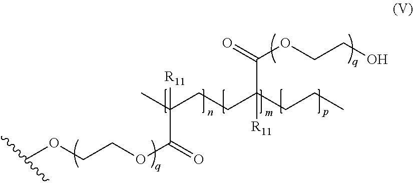

where R₁₁ can be H or an alkyl group, q can be 1 to 10, m can be always >0, n+m=0.01 to 0.2, p can be 0.8 to 0.99, wherein n+m+p=1 and the monomer units corresponding to q, n, m, and p can be randomly distributed, where q is repeat units, and n, m, p are mole fractions. In terms of mole percent (mol. %), m can be always >0, n+m can range from 1 to 20 mol. %, p can range from 80 to 99 mol. %, wherein the total mol. % of n+m+p=100 mol. %. In a more preferred aspects, the vitrimer has the structure of:

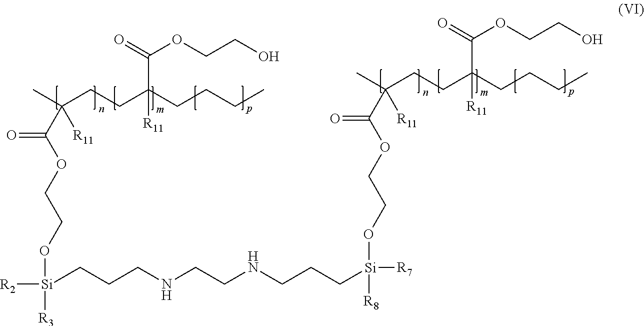

where R₂, R₃, R₇, R₈, R₁₁, m, n, and p are as previously defined. The vitrimer polymer compositions can be recyclable. At least 10 wt. % of the vitrimer polymer composition can be insoluble in xylene at 100° C. for 24 hours.

In another aspect of the present invention, methods of making semi-crystalline vitrimer polymer compositions are described. A method of making a semi-crystalline vitrimer polymer composition can include extruding a silyl (Si) ether crosslinking agent with a hydroxyl (OH)-functionalized polymer. The number of OH of the hydroxyl functionalized polymer to the OH or alkoxy groups of the silicon from the silyl ether crossing agent should be greater than 1:1. Extruding can include adding the silyl ether crosslinking agent in the absence of a solvent to the hydroxyl-functionalized polymer. Extrusion temperatures can be from 110° C. to 300° C., preferably 120° C. to 180° C., or any range or value there between. Extrusion times can be 1, 5, 10, or 15 minutes to 120 minutes, preferably 1, 5, 10, or 15 minutes to 60 minutes, more preferably 1, 5, 10, or 15 minutes to 30 minutes, or even more preferably 1 or 5 minutes to 20 minutes, or 5 minutes to 20 minutes, or even 10 minutes to 20 minutes. In certain instances, the extrusion time can be 1 minute to 15 minutes or 10 minutes to 15 minutes. The silyl ether crosslinking agent can have a structure of:

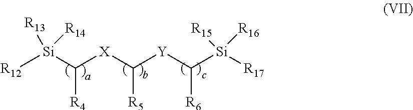

where: R₁₂, R₁₃, R₁₄, R₁₅, R₁₆, and R₁₇ can each be independently an aliphatic group, a hydroxyl group (OH) or an alkoxy group with the proviso that at least one of R₁₂, R₁₃, or R₁₄, and at least one of R₁₅, R₁₆, or R₁₇ is a OH or an alkoxyl group; R₄, R₅, and R₆ can each be independently H or an aliphatic group; X and Y can each be independently NH, O, S, CH₂; and a can be 1 to 10, b can be 1 to 10, and c can be 1 to 10. In some embodiments, X and Y are both NH. In some aspects, the hydroxyl-functionalized polymer can have a structure of:

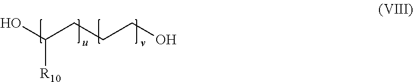

where R₁₀ can each be H or an alkyl, u can be 0 to 1, v can be 0 to 1, wherein u+v=1 and the monomer units corresponding to u and v can each be randomly distributed. In terms of mole percent (mol. %), u can range from 0 to 100 mol. %, v can range from 0 to 100 mol. %, wherein the total mol. % of u+v=100 mol. %. In some aspects, the hydroxyl-functionalized polymer can have a structure of:

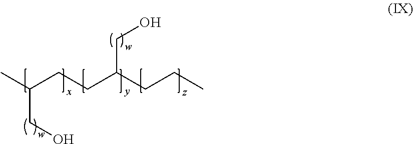

where y can be >0, x+y=0.01 to 0.2, z can be 0.8 to 0.99, wherein x+y+z=1 and w can be 0 to 20, and the monomer units corresponding to x, y, and z can be randomly distributed, where w is repeat units, and x, y, z are mole fractions. In terms of mole percent (mol. %), y can be >0, x+y can range from 1 to 20 mol. %, z can range from 80 to 99 mol. %, wherein the total mol. % of x+y+z=100 mol. %. In another aspect of the present invention, the hydroxyl-functionalized polymer can have a structure of:

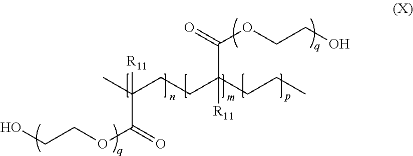

where R₁₁ can be H or an alkyl group, q can be 1 to 10, m can be >0, n+m=0.01 to 0.2, p can be 0.8 to 0.99, wherein n+m+p=1 and the monomer units corresponding to n, m, andp can each be randomly distributed, where q is repeat units, and n, m, p are mole fractions. In terms of mole percent (mol. %), m can be >0, n+m can range from 1 to 20 mol. %, p can range from 80 to 99 mol. %, wherein the total mol. % of, and wherein the total mol. % of n+m+p=100 mol. %. Combinations of the above described polymers and/or combinations of hydroxy-functionalized polymers can be used to make the semi-crystalline vitrimer polymer compositions of the present invention.

In some aspects, the vitrimer polymer compositions of the present invention can have a hot set elongation below 30%, such as 0.5 to 25% as measured for a sample with initial length 20 mm, thickness 0.5 mm, where the samples were allowed to creep for 10 min. at 200° C. under 0.5 g load. In some aspects, the vitrimer polymer compositions of the present invention can have an activation energy of topological rearrangement (Eₐ) greater than 100 kj/mol, such as 125 kJ/mol to 175 kJ/mol and/or topology-freezing transition temperature (Tᵥ) greater than 50° C., such as 55° C. to 100° C. or 60° C. to 95° C.

In some aspects, the semi-crystalline vitrimer polymer compositions of the present invention can be comprised in an article of manufacture. It is also contemplated in the context of the present invention that the semi-crystalline vitrimer materials (the phrases vitrimer materials and vitrimer compositions can be used interchangeably in this specification) can be used to produce sheets, films, foams, and/or 3D printed materials. The semi-crystalline vitrimer materials can be used alone or in combination with other polymer material (e.g., blends) to produce such sheets, films, foams, and/or 3D printed materials.

Other embodiments of the invention are discussed throughout this application. Any embodiment discussed with respect to one aspect of the invention applies to other aspects of the invention as well and vice versa. Each embodiment described herein is understood to be embodiments of the invention that are applicable to other aspects of the invention. It is contemplated that any embodiment or aspect discussed herein can be combined with other embodiments or aspects discussed herein and/or implemented with respect to any method or composition of the invention, and vice versa. Furthermore, compositions of the invention can be used to achieve methods of the invention.

The following includes definitions of various terms and phrases used throughout this specification.

“Semi-crystalline” when used with semi-crystalline vitrimer compositions, semi-crystalline vitrimer materials, or semi-crystalline vitrimers refers to a degree of crystallinity of at least 5%, preferably at least 7%, or more preferably at least 10% and preferably up to 90% or up to 50%. In more preferred aspects, the degree of crystallinity is 7% to 50%, 10% to 50%, 7% to 15%, 10% to 13%, or 10.5% to 12.5%. The degree of crystallinity can be measured by differential scanning calorimetry (DSC) using a DSC Q100 from TA Instruments. An example of such a measurement is provided at the bottom of Table 1 in Example 1 of the present application.

A “hydroxy functionalized polymeric group” refers to a polymer that can include a OH functional group(s) in the polymer structure, a polymer repeating unit, or a terminal OH.

An “aliphatic group” is an acyclic or cyclic, saturated or unsaturated carbon group, excluding aromatic compounds. A linear aliphatic group does not include tertiary or quaternary carbons. Non-limiting examples of aliphatic group substituents include halogen, hydroxyl, alkoxy, haloalkyl, haloalkoxy, carboxylic acid, ester, amine, amide, nitrile, acyl, thiol and thioether. A branched aliphatic group includes at least one tertiary and/or quaternary carbon. Non-limiting examples of branched aliphatic group substituents include alkyl, halogen, hydroxyl, alkoxy, haloalkyl, haloalkoxy, carboxylic acid, ester, amine, amide, nitrile, acyl, thiol and thioether. A cyclic aliphatic group includes at least one ring in its structure. Polycyclic aliphatic groups may include fused, e.g., decalin, and/or spiro, e.g., spiro[5.5]undecane, polycyclic groups. Non-limiting examples of cyclic aliphatic group substituents include alkyl, halogen, hydroxyl, alkoxy, haloalkyl, haloalkoxy, carboxylic acid, ester, amine, amide, nitrile, acyl, thiol and thioether.

An alkyl group is linear or branched, substituted or unsubstituted, saturated hydrocarbon. Non-limiting examples of alkyl group substituents include alkyl, halogen, hydroxyl, alkoxy, haloalkyl, haloalkoxy, carboxylic acid, ester, amine, amide, nitrile, acyl, thiol and thioether. “Alkenyl” and “alkenylene” mean a monovalent or divalent, respectively, straight or branched chain hydrocarbon group having at least one carbon-carbon double bond (e.g., ethenyl (—HC═CH₂). “Alkynyl” means a straight or branched chain, monovalent hydrocarbon group having at least one carbon-carbon triple bond (e.g., ethynyl). “Alkoxy” means an alkyl group linked via an oxygen (i.e., alkyl-O—), for example methoxy. “Cycloalkyl” and “cycloalkylene” mean a monovalent and divalent cyclic hydrocarbon group, respectively, of the formula —CₙH₂ₙ₋ₓ and —CₙH₂ₙ₋₂ₓ— wherein x is the number of cyclizations.

An “aromatic” group is a substituted or unsubstituted, mono- or polycyclic hydrocarbon with alternating single and double bonds within each ring structure. Non-limiting examples of aryl group substituents include alkyl, halogen, hydroxyl, alkoxy, haloalkyl, haloalkoxy, carboxylic acid, ester, amine, amide, nitrile, acyl, thiol and thioether. Arylalkylene” means an alkylene group substituted with an aryl group (e.g., benzyl). The prefix “halo” means a group or compound including one or more halogen (F, Cl, Br, or I) substituents, which can be the same or different. The prefix “hetero” means a group or compound that includes at least one ring member that is a heteroatom (e.g., 1, 2, or 3 heteroatoms), wherein each heteroatom is independently N, O, S, or P. Aromatic groups include “heteroaryl” group or a “heteroaromatic” group, which is a mono-or polycyclic hydrocarbon with alternating single and double bonds within each ring structure, and at least one atom within at least one ring is not carbon. Non-limiting examples of heteroaryl group substituents include alkyl, halogen, hydroxyl, alkoxy, haloalkyl, haloalkoxy, carboxylic acid, ester, amine, amide, nitrile, acyl, thiol and thioether.

“Substituted” means that the compound or group is substituted with at least one (e.g., 1, 2, 3, or 4) substituents instead of hydrogen, where each substituent is independently nitro (—NO₂), cyano (—CN), hydroxy (—OH), halogen, thiol (—SH), thiocyano (—SCN), C₁₋₆ alkyl, C₂₋₆ alkenyl, C₂₋₆ alkynyl, C₁₋₆ haloalkyl, C₁₋₉ alkoxy, C₁₋₆ haloalkoxy, C₃₋₁₂ cycloalkyl, C₅₋₁₈ cycloalkenyl, C₆₋₁₂ aryl, C₇₋₁₃ arylalkylene (e.g., benzyl), C₇₋₁₂ alkylarylene (e.g., toluyl), C₄₋₁₂ heterocycloalkyl, C₃₋₁₂ heteroaryl, C₁₋₆ alkyl sulfonyl (—S(═O)₂-alkyl), C₆₋₁₂ arylsulfonyl (—S(═O)₂-aryl), or tosyl (CH₃C₆H₄SO₂—), provided that the substituted atom's normal valence is not exceeded, and that the substitution does not significantly adversely affect the manufacture, stability, or desired property of the compound. When a compound is substituted, the indicated number of carbon atoms is the designated number of carbon atoms excluding the substituents.

The phrase “mechanical constraint” refers to the application of a mechanical force, locally or to all or part of the article such that the article's shape is transformed (e.g., deformed or formed). Non-limiting examples of mechanical constraints include pressure, molding, blending, extrusion, blow-molding, injection-molding, stamping, twisting, flexing, pulling and shearing.

The term “mole fraction” when used in reference to specific units within a polymer chain is defined to be equal to the number of moles of a specific unit from a polymer chain, divided by the total number of moles of all summed units from the same polymer chain. Mole fraction is a unitless expression and the mole fractions of all components of the polymer chain when added together equal to 1.

The terms “about” or “approximately” are defined as being close to as understood by one of ordinary skill in the art. In one non-limiting embodiment, the terms are defined to be within 10%, preferably within 5%, more preferably within 1%, and most preferably within 0.5%.

The terms “wt. %,” “vol. %,” or “mol. %” refers to a weight percentage of a component, a volume percentage of a component, or molar percentage of a component, respectively, based on the total weight, the total volume of material, or total moles, that includes the component. In a non-limiting example, 10 grams of component in 100 grams of the material is 10 wt. % of component.

The term “substantially” and its variations are defined to include ranges within 10%, within 5%, within 1%, or within 0.5%.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having” in the claims, or the specification, may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The semi-crystalline vitrimers that include the silyl ethers of the present invention can “comprise,” “consist essentially of,” or “consist of” particular ingredients, components, compositions, etc. disclosed throughout the specification. With respect to the transitional phrase “consisting essentially of,” in one non-limiting aspect, a basic and novel characteristic of silyl ethers and polymers the present invention are their abilities to be extruded into semi-crystalline vitrimer materials.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is non-limiting example of a process of producing a vitrimer polymer composition of the present invention.

FIG. 2 is non-limiting example of a process of producing a polyethylene-hydroxyl terminated (meth)acrylate (PE-HEMA) vitrimer polymer composition of the present invention.

FIG. 3 shows dynamic mechanical thermal analysis (DMTA) graphs for PE-HEMA copolymer and vitrimers 1-4 of the present invention having different crosslink densities.

FIG. 4 shows graphs of frequency sweep at 180° C. of PE-HEMA and vitrimers 1, 2 and 4 of the present invention.

FIG. 5 A) shows graphs stress relaxation of vitrimer 2 of the present invention at 170° C., 190° C., and 210° C. Fit line through 170° C. points has the equation of y=1.05e\hat{ }−(x/51197)\hat{ }0.23 and R²=0.999, fit line through 190° C. points has the equation of y=1.10e)\hat{ }−(x/21472)\hat{ }0.23 and R²=0.999, Fit line through 210° C. points has the equation of y=1.10e)\hat{ }−(x/8300)\hat{ }0.27 and R²=0.997. B) Arrhenius plot of relaxation times of vitrimer 2

FIG. 6 shows a linear relationship between complex viscosity (η*) at various frequencies of vitrimers 1, 2 and 4 of the present invention.

FIG. 7 shows η* dependency on frequency of PE-HEMA and vitrimers 1-4 of the present invention as determined by rheology frequency sweeps.

FIGS. 8A-8D show representative (8A) stress-strain curves and (8B) Young's modulus, (8C) ultimate strength and (8D) strain at break of PE HEMA and vitrimers 1-4 of the present invention.

FIG. 9 shows representative tensile curves of vitrimer 1 of the present invention tested as synthesized and after up to a fourth reprocessing cycle.

FIG. 10 shows representative tensile curves of PE-HEMA and vitrimers 1-4 of the present invention before and after submerging in water for 24 h at room temperature.

FIG. 11 Hot set elongation of vitrimers 1-4.

While the invention is susceptible to various modifications and alternative forms, specific embodiments thereof are shown by way of example in the drawings. The drawings may not be to scale.

### DETAILED DESCRIPTION OF THE INVENTION

A discovery has been made that provides a solution to at least some of the problems associated with production of vitrimers. The discovery is premised on the idea of extruding a functionalized silyl ether with a polymer having a reactive hydroxyl group under conditions suitable (e.g., 120° C. to 300° C.) to react the silyl ether with the hydroxyl groups to produce a semi-crystalline vitrimer material. Such a methodology can provide a wide range of high purity semi-crystalline vitrimer materials in an efficient manner.

These and other non-limiting aspects of the present invention are discussed in further detail in the following sections.

### A. Semi-Crystalline Vitrimer Polymeric Compositions

At least two hydroxy functionalized polymers can be linked with a silyl ether to form a vitrimer polymeric composition of the present invention. The produced vitrimer polymer composition can be semi-crystalline and/or recyclable. Such a vitrimer can have the following formula:

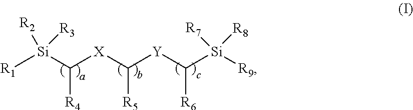

where R₁ and R₉ can each independently be a hydroxyl-functionalized polymeric group, R₂, R₃, R₇, and R₈ can each independently be a hydroxyl-functionalized polymeric group, an aliphatic group, or an alkoxy group, and R₄, R₅, and R₆ can each independently be H or an aliphatic group. Non-limiting examples of polymers include hydroxyl-functionalized polyolefin, a hydroxyl functionalize polycarbonate, or a hydroxyl-functionalized polymeric group polyester-. In a preferred embodiment, R₁, R₂, R₃, R₇, R₈ and R₉ can each independently be a hydroxyl-functionalized polyolefin-based polymer. In some embodiments, R₁ and R₉, preferably R₁, R₂, R₃, R₇, R₈ and R₉, can be the polymers of structures (II) through (V) described above. X and Y can each independently be NH, O, S, or CH_{2.} In a preferred embodiment, X and Y are NH. The hydrocarbon units unit represented by a, b, and c, can each be 1 to 10, or at least any one of, equal to any one of, or between any two of 1, 2, 3, 4, 5, 6, 7, 8, 9, 10. In certain embodiments, when X and Y are both NH, R₁ and R₉ are not styrene-based polymers. The vitrimer polymeric composition can have 3 to 10 or at least any one of, equal to any one of, or between any two of 3, 4, 5, 6, 7, 8, 9, and 10 crosslinks per polymer chain. Minimal crosslinking allows more efficient processing of the semi-crystalline vitrimer polymer material into molded articles. By way of example, the semi-crystalline vitrimer polymer products of the present invention can be compression molded for 10 minutes at 180° C. versus 360 minutes at 160° C. for solution based vitrimer chemistry.

In one non-limiting example, the semi-crystalline vitrimer can include the following structure:

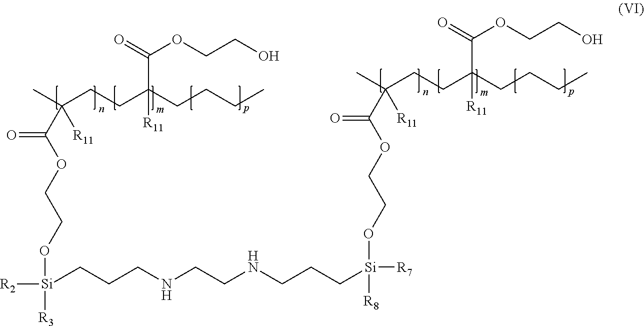

where R₂, R₃, R₇, R₈, and R₁₁ are as defined above. In another example, the semi-crystalline vitrimer polymer composition can include the following structure:

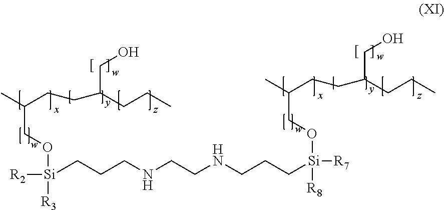

where R₂, R₃, R₇ and R₈ are as defined above. In yet another example, the semi-crystalline vitrimer polymer composition can include the following structure:

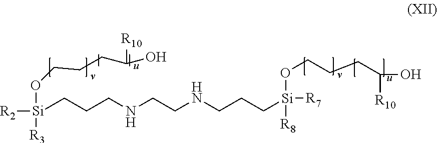

where R₂, R₃, R₇, R₈, and R₁₀ are as defined above.

### B. Materials

### 1. Functionalized Polymers

The semi-crystalline functionalized vitrimer polymers of the present invention can include groups derived from a hydroxyl (OH)-functionalized polymers. In a preferred embodiment, the polymer can have at least 2 hydroxyl functionalities. OH-functionalized polymers can include polyvinyl alcohol (e.g., poly(ethyl vinyl alcohol)), PE-HEMA, polycarbonates containing hydroxyl groups (e.g., telechelic polycarbonate), polyesters that include hydroxyl groups (e.g., polyethylene terephthalate-based polymers, polybutylene terephthalate-based polymers), telechelic polymers, or the like. Non-limiting examples of hydroxyl-functionalized polymers are represented by structures (VIII) through (X). The hydroxyl-functionalized polymer of structure (VIII) as shown can be a polyolefin hydroxyl-functionalized polymer.

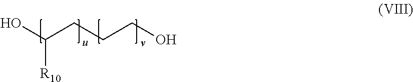

where R₁₀ can each be H or an alkyl, u can be 0 to 1, v can be 0 to 1, u+v=1 and the monomer units corresponding to u and v can each be randomly distributed. In terms of mole percent (mol. %), u can range from 0 to 100 mol. %, v can range from 0 to 100 mol. %, wherein the total mol. % of u+v=100 mol. %. Non-limiting examples of alkyl groups include C₁₋₁₀ alkyl groups, which can include methyl, ethyl, n-propyl isopropyl, n-butyl, sec-butyl, tent-butyl, n-pentyl, 2-methylbutan-2-yl, 2,2-dimethylpropyl, 3-methylbutyl, pentan-2-yl, pentan-3-yl, 3-methylbutan-2-yl, 2-methylbutyl, hexyl, heptyl, octyl, nonyl, and decyl. The value for u can be 0 to 1, or at least any one of, equal to any one of, or between any two of 0, 0.001, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1, where u is mole fraction. The value for v can be 0 to 1, or at least any one of, equal to any one of, or between any two of 0, 0.001, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9 and 1, where v is mole fraction. In one embodiment, Rio is hydrogen or methyl, ethyl, propyl or butyl.

Another example of a polyolefin hydroxyl-functionalized polymer is structure (IX) shown below.

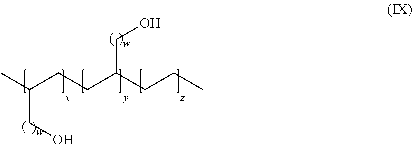

where y is >0, x+y=0.01 to 0.2, z can be 0.8 to 0.99, x+y+z=1 and w can be 0 to 20, and the monomer units corresponding to x, y, and z can be randomly distributed, where w is repeat units, and x, y, z are mole fractions. In terms of mole percent (mol. %), y can be >0, x+y can range from 1 to 20 mol. %, z can range from 80 to 99 mol. %, wherein the total mol. % of, x+y+z=100 mol. %. The value fory can be greater than zero such that x+y is equal to 0.01 to 0.2, where x and y are mole fractions. For example, y can be 0.001 to 0.19 or at least any one of, equal to any one of, or between any two of 0, 0.001, 0.01, 0.02, 0.03, 0.04, 0.05, 0.06, 0.07, 0.08, 0.09, 0.1, 0.12, 0.13, 0.14, 0.15, 0.16, 0.17, 0.18, and 0.19, where y is mole fraction. The value for x can be 0 to 0.19, or at least any one of, equal to any one of, or between any two of 0, 0.001, 0.005, 0.01, 0.02, 0.03, 0.04, 0.05, 0.06, 0.07, 0.08, 0.09, 0.1, 0.12, 0.13, 0.14, 0.15, 0.16, 0.17, 0.18, and 0.19, where x is mole fraction. The value for z can be 0.8 to 0.99, or at least any one of, equal to any one of, or between any two of 0.8, 0.85, 0.86, 0.87, 0.88, 0.89, 0.9, 0.91, 0.92, 0.93, 0.94, 0.95, 0.96, 0.97, 0.98 and 0.99, where z is mole fraction. The value for w can be 1 to 20, or at least any one of, equal to any one of, or between any two of 0, 1, 2, 3, 4, 5, 6, 7, 8, 9, 10, 11, 12, 13, 14, 15, 16, 17, 18, 19, and 20.

In yet another example, the hydroxyl-functionalized polymer can be an ethylene-acrylate polymer having structure (X) shown below.

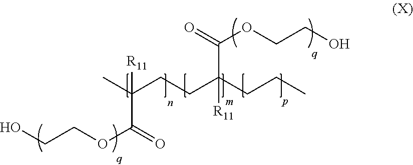

where R₁₁ can be H or an alkyl group, q can be 1 to 10, m can be >0, n+m=0.01 to 0.2, p can be 0.8 to 0.99, n+m+p=1 and the monomer units corresponding to n, m, and p can each be randomly distributed, where q is repeat units, and n, m, p are mole fractions. In terms of mole percent (mol. %), m can be >0, n+m can range from 1 to 20 mol. %, p can range from 80 to 99 mol. %, wherein the total mol. % of, n+m+p=100 mol. %. Non-limiting examples of alkyl groups include C₁₋₁₀ alkyl groups, which can include methyl, ethyl, n-propyl isopropyl, n-butyl, sec-butyl, tent-butyl, n-pentyl, 2-methylbutan-2-yl, 2,2-dimethylpropyl, 3-methylbutyl, pentan-2-yl, pentan-3-yl, 3-methylbutan-2-yl, 2-methylbutyl, hexyl, heptyl, octyl, nonyl, and decyl. The value for q can be 1 to 10, or at least any one of, equal to any one of, or between any two of 1, 2, 3, 4, 5, 6, 7, 8, 9, and 10. The value for m can be greater than zero such that n+m is equal to 0.01 to 0.2, where n and m are mole fractions. For example, m can be 0.001 to 0.19 or at least any one of, equal to any one of, or between any two of 0, 0.001, 0.01, 0.02, 0.03, 0.04, 0.05, 0.06, 0.07, 0.08, 0.09, 0.1, 0.12, 0.13, 0.14, 0.15, 0.16, 0.17, 0.18, and 0.19, where m is mole fraction. The value for n can be 0 to 0.19, or at least any one of, equal to any one of, or between any two of 0, 0.001, 0.005, 0.01, 0.02, 0.03, 0.04, 0.05, 0.06, 0.07, 0.08, 0.09, 0.1, 0.12, 0.13, 0.14, 0.15, 0.16, 0.17, 0.18, and 0.19, where n is mole fraction. The value for p can be 0.8 to 0.99, or at least any one of, equal to any one of, or between any two of 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, and 0.99, where p is mole fraction. In one embodiment, Ru is hydrogen, methyl, ethyl, propyl or butyl.

The semi-crystalline vitrimer polymeric composition can include one or more homopolycarbonates, copolycarbonates or polyester carbonates that are telechelic (e.g., they include a cross-linkable hydroxyl functionality). A non-limiting example of a polycarbonate can include repeating units as shown in structure XIII.

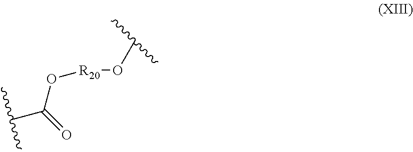

where R₂₀ is an organic groups such as an aliphatic alicyclic, or aromatic group, or any combination thereof. R₂₀ can be a C₆ to C₃₆ aromatic group. R₂₀ can include one or more hydroxyl functionalities. Polycarbonates having hydroxy terminal groups, can be presented by the structure.

HO—R₂₁-polycarbonate-R₂₂—OH where R₂₁ and R₂₂ can each can be an organic group such as an aliphatic alicyclic, or aromatic group, or any combination thereof. In some embodiments, R₂₁ to R₂₂ is C₇ aromatic group. R₂₁ and R₂₂ can include one or more hydroxyl functionalities.

The functionalized polymers of the present invention can be made through a high-pressure free radical process, preferably a continuous process. In the process, suitable monomers can be polymerized under conditions to produce the functionalized polymers of the present invention. By way of example, a C₂₋₅ olefin material and a hydroxy functionalized monomer can be contacted with a polymerization initiator at conditions suitable to produce the functionalized hydroxyl terminated polymer of the present invention. The flow of the reactants can be adjusted to control the degree of polymerization. Polymerization conditions can include temperature and pressures. Reaction temperatures can be at least any one of, equal to one of, or between any two of 100° C., 125° C., 150° C., 175° C., 200° C., 225° C., 250° C., 275° C., 300° C., 325° C. and 350° C. Reaction pressures can be at least any one of, equal to any one of, or between any two of 180 MPa, 190 MPa, 200 MPa, 210 MPa, 220 MPa, 230 MPa, 240 MPa, 250 MPa, 260 MPa, 270 MPa, 280 MPa, 290 MPa, 300 MPa, 310 MPa, 320 MPa, 330 MPa, 340 MPa and 350 MPa. Any peroxide polymer initiator can be used and are available from commercial vendors such as Arkema (France). Non-limiting examples of peroxide initiators include diacyl peroxide, t-butyl peroxypivalate or the like.

Suitable C₂₋₅ olefin monomeric materials can include ethylene, propylene, butylene, or pentene, or mixtures thereof. Suitable hydroxy functionalized materials include 2-hydroxyethyl methacrylate (CAS No. 868-77-9) The hydroxy functionalized material concentration in the reactant mixture is less than 10 mol. %, equal to any one of, or between any two of 9 mol. %, 8 mol. %, 7 mol. %, 6 mol. %, 5 mol. %, 4 mol. %, 3 mol. %, 2 mol. %, 1 mol. %, 0.9 mol. %, 0.8 mol. %, 0.7 mol. %, 0.6 mol% or 0.5 mol. %, 0.4 mol. %, 0.3 mol. %, 0.2 mol%, 0.1 mol%, but greater than 0 mol. %. In some instances, the hydroxy functionalized material concentration is between 0.1 mol. % to 0.5 mol. %.

### 2. Silyl Ethers

Silyl ether crosslinking agents used in the present invention can be any known silyl ether that can be reacted with a hydroxyl group. A non-limiting example of a silyl ether is represented by structure (VII).

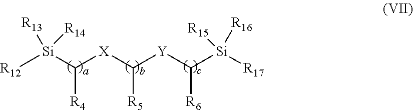

where: R₁₂, R₁₃, R₁₄, R₁₅, R₁₆, and R₁₇ can each be independently an aliphatic group, a hydroxyl group (OH) or an alkoxy group with the proviso that at least one of R₁₂, R₁₃, or R₁₄, and at least one of R₁₅, R₁₆, or R₁₇ is a OH or an alkoxyl group. Non-limiting examples of an aliphatic groups include C₁₋₁₀ aliphatic groups, which can include methyl, ethyl, n-propyl isopropyl, n-butyl, sec-butyl, tent-butyl, n-pentyl, 2-methylbutan-2-yl, 2,2-dimethylpropyl, 3-methylbutyl, pentan-2-yl, pentan-3-yl, 3-methylbutan-2-yl, 2-methylbutyl, hexyl, heptyl, octyl, nonyl, and decyl. Non-limiting examples of alkoxy groups include C₁₋₅ alkoxy groups, which can include methoxy, ethoxy, propoxy, butoxy, or pentoxy. R₄, R₅, and R₆ can each be independently H or an aliphatic group as previous defined. X and Y can each independently be NH, O, S, CH₂, or combinations thereof. The values for a, b, and c can be 1 to 10, or at least any one of, equal to any one of, or between any two of 1, 2, 3, 4, 5, 6, 7, 8, 9, and 10. In one instance X and Y can be NH₂ and the silyl ether can have the structure:

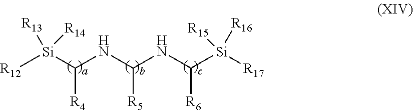

where R₄, R₅, R₆ R₁₂, R₁₃, R₁₄, R₁₅, R₁₆, and R₁₇ are as previously defined. In some embodiments, R₁₂, R₁₃, R₁₄, R₁₅, R₁₆, and R₁₇ are methoxy, R₄, R₅, and R₆ can each be H, a and c can be 3, and b can be 2 to give the following structure:

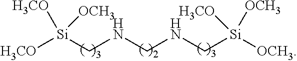 [SMILES: CO[Si](CNCNC[Si](OC)(OC)OC)(OC)OC]

### C. Process to Produce Semi-Crystalline Vitrimers of the Present Invention

Vitrimers of the present invention can be produced through a condensation reaction of the silyl ether with the functionalized polyolefin. The vitrimers can be produced using an extrusion process, which provides the advantage of minimal to no solvent usage and/or no catalyst requirement. The hydroxyl-functionalized polymer can be contacted with an amount of silyl ether under conditions sufficient to react the linking material with the hydroxy group to form the vitrimer (e.g., a silyloxy linkage). In some instances, the hydroxyl-functionalized polymer and silyl ether can be fed as a mixture or in individual stream into the throat of a twin-screw extruder via a hopper. The extruder can be generally operated at a temperature higher than that necessary to cause the functionalized polymer to flow and sufficient to promote the condensation reaction. Reaction conditions can include temperatures from 120° C. to 300° C., preferably 140° C. to 160° C., or at least any one of, equal to any one of, or between any two of 120° C., 130° C., 140° C., 150° C., 160° C., 170° C., 180° C., 190° C., 200° C., 210° C., 220° C., 230° C., 240° C., 250° C., 260° C., 270° C., 280° C., 290° C. and 300° C. Extrusion times can be 1, 5, 10, or 15 minutes to 120 minutes, preferably 1, 5, 10, or 15 minutes to 60 minutes, more preferably 1, 5, 10, or 15 minutes to 30 minutes, or even more preferably 1 or 5 minutes to 20 minutes, or 5 minutes to 20 minutes, or even 10 minutes to 20 minutes. In certain instances, the extrusion time can be 1 minute to 15 minutes or 10 minutes to 15 minutes at a temperature of 120° C. to 180° C., or any range or value there between. At least a slight excess of hydroxy material amount is used during an extrusion process. The amount of cross-linking can be controlled by the amount of silyl ether present and/or the amount of hydroxyl groups to be reacted. For example, an ethyl vinyl alcohol type polymer can only have a minimal amount of OH groups reacted (e.g., 0.1 mol. %). In another example, a telechelic polyester or polycarbonate a majority of the OH groups can be reacted (e.g., at least 80 mol. %). In some embodiments, the number of reactive OH groups from the polymer to the number of O functionalized groups (OH or alkoxy) groups on the silicon atom of the silyl ether is greater than and not equal to 1:1, or 2:1 to 100:1, or any range or value there between. By way of example, the number ratio can be 3:1 to 10:1, or 4:1 to 6:1.

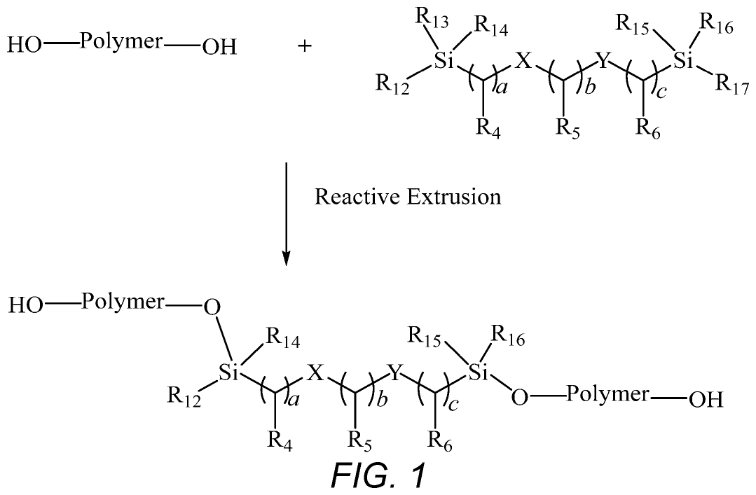

The extrudates can be immediately quenched in a water bath and pelletized. Such pellets can be used for subsequent molding, shaping, or forming. A non-limiting example of preparation of silyl linked vitrimers is shown in the reaction scheme shown in FIG. 1. The cross-linking of the silyl ether with the hydroxyl-functionalized polymer can be determined through solubility of the material in xylene at 100° C. for 24 hours. Since the starting polymers are soluble in xylene at these conditions, detection of insoluble material can be used as an indication of cross-linking. The vitrimer polymer composition can be partially insoluble in xylene at 100° C. for 24 hours. The vitrimer polymer composition can have an insoluble fraction of at least 10 wt. % to 100 wt. %, or at least any one of, equal to any one of, or between any two of 10, 15, 20, 25, 30, 35, 40, 45, 50, 55, 60, 65, 70, 75, 80, 85, 90, 95 and 100 wt. %

The vitrimers, functionalized polymers, and copolymers of the present invention can be produced as films, sheets, foams, particles, granules, beads, rods, plates, strips, stems, tubes, etc. via any process known to those skilled in the art. By way of example, extrusion, casting, compression molding can be used. These elemental components based on the functionalized polymers, copolymers and/or vitrimers of the present invention, are easy to store, transport and handle.

The components can be subjected to heat and/or mechanical constraint through blending, extrusion, molding (injection or extrusion), blow-molding, or thermoforming to form an article of manufacture. This transformation can include mixing or agglomeration with one or more additional components chosen from: one or more polymers, pigments, dyes, fillers, plasticizers, fibers, flame retardants, antioxidants, lubricants.

### D. Articles of Manufacture

The semi-crystalline vitrimers of the present invention can be used in all types of applications and articles of manufacture. Non-limiting examples of the types of applications that the materials of the present invention can be used in include motor vehicles, airplanes, boats, aeronautical construction or equipment or material, electronics, sports equipment, construction equipment and/or materials, printing, packaging, biomedical, and cosmetics. Non-limiting examples of articles of manufacture can include leak tight seals, thermal or acoustic insulators, tires, cables, sheaths, footwear soles, packagings, coatings (paints, films, cosmetic products), patches (cosmetic or dermopharmaceutical), furniture, foams, systems for trapping and releasing active agents, dressings, elastic clamp collars, vacuum pipes, pipes and flexible tubing for the transportation of fluids. Examples of packaging materials include films and/or pouches, especially for applications such as food and/or beverage packaging applications, for health care applications, and/or pharmaceutical applications, and/or medical or biomedical applications. The materials can be in direct contact with an item intended for human or animal use, such as for example a beverage, a food item, a medicine, an implant, a patch or another item for nutritional and/or medical or biomedical use. The articles of manufacture can exhibit good resistance to tearing and/or to fatigue. The articles of manufacture can include rheological additives or additives for adhesives and hot-melt adhesives. In these applications, the materials according to the invention can be used as such or in single-phase or multiphase mixtures with one or more compounds such as petroleum fractions, solvents, inorganic and organic fillers, plasticizers, tackifying resins, antioxidants, pigments and/or dyes, for example in emulsions, suspensions or solutions.

In an embodiment, an article based on the semi-crystalline vitrimers of the present invention can be manufactured by molding, filament winding, continuous molding or film-insert molding, infusion, pultrusion, RTM (resin transfer molding), RIM (reaction-injection molding), 3D printing, or any other method known to those skilled in the art. The means for manufacturing such an article are well known to those skilled in the art. In some embodiments, the vitrimers of the present invention and/or other ingredients can be mixed and introduced into a mold and the temperature raised.

Films that include the semi-crystalline vitrimers of the present invention can have various thicknesses. For example, films can be from 1 micrometer to 1 mm thick. Multilayer films of the present invention can be produced by co-extrusion or other bonding methodology.

In some embodiments, the semi-crystalline vitrimers of the present invention, on account of their particular composition, can be transformed, repaired, and/or recycled by raising the temperature of the article. Below the glass transition (Tg) temperature, the vitrimers are vitreous-like and/or have the behavior of a rigid solid body. Above the Tg temperature (or Tm for semi-crystalline polymers), the vitrimers become flowable and moldable. Below the Tg or the solidification temperature, in case of semi-crystalline materials, the material behaves like a hard glassy solid, whereas above, the material is soft and rubber like. The other temperature of importance is related to the exchange reactions of the vitrimer network called the topology freezing temperature (Tv). Until exchange reactions become fast enough, the network is set, and the topology cannot change. The convention is to place Tv at the solid to liquid transition point where a viscosity of 10¹² Pa·s is reached. The vitrimer will first behave like a glassy solid below Tg in case of amorphous materials, then like an elastomer above Tg, and finally, when Tv is reached, the viscosity will decline following the Arrhenius law because viscosity is predominantly controlled by the exchange reactions. For semi-crystalline polymers, also the melting temperature (Tm) and the crystallization temperature (Tc) has to be considered. For sufficiently crystalline polymers (crystalline network leading to elastic network response), Tm/Tc will have a similar influence as Tg, below which the topology is frozen due to the physical connections provided by the crystals inhibiting flow and therefore the ability to measure Tv.

Transforming at least one article made from a vitrimer of the present invention can include application to the article of a mechanical constraint at a temperature (T) above the Tm of the material. The mechanical constraint and temperature are selected to enable transformation within a time that is compatible with industrial application of the process. By way of example, a transformation can include applying a mechanical constraint at a temperature (T) above the Tm of the material of which the article is composed, and then cooling to room temperature, optionally with application of at least one mechanical constraint. By way of example, an article of manufacture such as a strip of material can be subjected to a twisting action. In another example, pressure can be applied using a plate or a mold onto one or more faces of an article of the invention. Pressure can also be exerted in parallel onto two articles made of material in contact with each other so as to bring about bonding of these articles. In yet another example, a pattern can be stamped in a plate or sheet made of material of the invention. The mechanical constraint may also consist of a plurality of separate constraints, of identical or different nature, applied simultaneously or successively to all or part of the article or in a localized manner. Raising of the temperature of the article or manufacture or of any functionalized polymers, copolymers, and/or vitrimer of the present invention can be performed by any known means such as heating by conduction, convection, induction, spot heating, infrared, microwave or radiant heating. A way for bringing about an increase in temperature can include an oven, a microwave oven, a heating resistance, a flame, an exothermic chemical reaction, a laser beam, a hot iron, a hot-air gun, an ultra-sonication tank, a heating punch, etc. In some embodiments, application of a sufficient temperature and a mechanical constraint to an article of manufacture that includes a vitrimer of the present invention, a crack or damage caused in a component formed from the material or in a coating based on the material can be repaired.

In some embodiments, an article made of the semi-crystalline vitrimer material of the invention may also be recycled, for example, by direct treatment of the article or by size reduction. For example, the broken or damaged article of manufacture can be repaired by means of a transformation process as described above and can thus regain its prior working function or another function. In another example, the article of manufacture can be reduced to particles by application of mechanical grinding, and the particles thus obtained can then be used in a process for manufacturing an article. In some embodiments, the reduced particles can be simultaneously subjected to a raising of temperature and a mechanical constraint; allowing them to be transformed into an article. The mechanical constraint that allows the transformation of particles into an article can include compression molding, blending or extrusion. Thus, molded articles can be made from the recycled material that includes the functionalized polymers, copolymers and/or vitrimers of the present invention.

In some embodiments, transforming the components or articles of manufacture can be performed by a final user without chemical equipment (no toxicity or expiry date or VOC, and no weighing out of reagents).

### EXAMPLES

The present invention will be described in greater detail by way of specific examples. The following examples are offered for illustrative purposes only, and are not intended to limit the invention in any manner. Those of skill in the art will readily recognize a variety of noncritical parameters which can be changed or modified to yield essentially the same results.

### Materials and Testing

Materials. Xylene, 1,2 dichlorobenzene (oDCB,), deuterated chloroform (CDCl₃, Sigma-Aldrich), deuterated tetrachloroethene (TCE-d2, Sigma-Aldrich), Irganox® 1010 (98%) were all obtained from (MilliporeSigma, USA). N,N′-bis[3-(trimethoxysilyl)propyl]-ethylenediamine (TMSPEDA, 95%) was obtained from BOC Sciences (USA), PE-HEMA copolymer was provided by SABIC® (Saudi Arabia). All materials were used as received unless otherwise stated.

Measurements. The molecular weight and polydispersity were studied by Size exclusion chromatography (SEC) measurements performed at 150° C. on a Polymer Char GPC IR® built around an Agilent GC oven model 7890, equipped with an auto sampler and the Integrated Detector IR_{4.} oDCB was used as an eluent at a flow rate of 1 mL/min. The SEC data were processed using Calculations Software GPC One®. The molecular weights were calculated with respect to polyethylene standards.

Melting temperatures (Tm) and enthalpies of the transition (AHm) were measured by differential scanning calorimetry (DSC) using a DSC Q100 from TA Instruments. The measurements were carried out at a heating and cooling rate of 10° C./min from −20° C. to 150° C. The transitions were deduced from the second heating.

Tensile tests were performed with a Zwick Z100 tensile tester equipped with a 100 N load cell. The tests were performed on compression molded tensile bars. The samples were pre-stressed to 0.3 MPa, then loaded with a constant cross-head speed of 50 mm/min.

Rheology was measured using TA Instruments DHR 2 equipped with parallel plate geometry. Compression molded discs with diameter of 25 mm and thickness of 1 mm were injection molded at 180° C. Frequency sweeps were measured from 100 to 0.01 rad/s (strain amplitude of 0.4%) at a temperature of 180° C. Stress relaxation measurements were performed at 170° C., 190° C. and 210° C., applying a step strain of 1%, then monitoring the stress for 20 000 s. Frequency sweeps were measured from 100 to 0.01 rad/s (strain amplitude of 0.4%) at a temperature of 180° C. Stress relaxation measurements were performed at 140° C., 160° C. and 180° C., applying a step strain of 1%, then monitoring the stress until at least 75% of the initial stress relaxed or until a constant stress value was observed.

Dynamical mechanical thermal analysis (DMTA) was measured using TA Instruments Q800 in tensile mode. The specimens were compressed molded at 180° C. Samples were measured from −140 to 200° C. with a heating speed of 3° C./min and a fixed oscillation (amplitude 10 micron, frequency 1 Hz).

### Example 1

### Reactive Extrusion to Prepare Vitrimers of the Present Invention

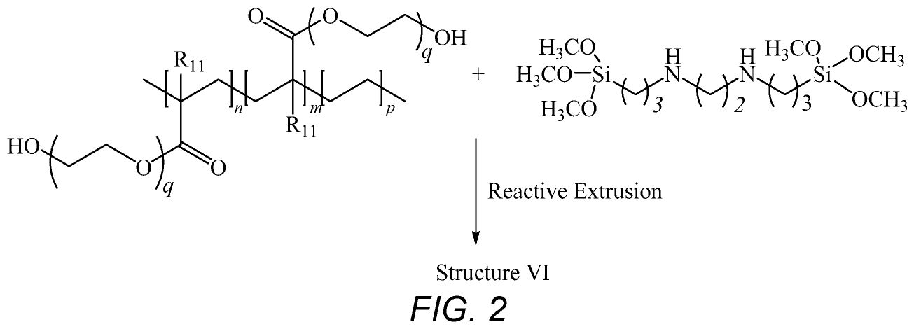

Typical procedure for reactive extrusion of PE-HEMA with TMSPEDA dynamic crosslinker (See, FIG. 2). PE-HEMA, TMSPEDA and Irganox® 1010 (1000 ppm) were mixed in a metal cup and subsequently fed into the 15 mL co-rotating twin-crew micro extruder. The reaction mixture was processed at 120° C. for 5 min and at 180° C. until the constant viscosity was reached (5-10 min) with a screw speed of 100 RPM after which the discharge valve was opened. The amount of TMSPEDA was determined from the weight ratio of the PE-HEMA and TMSPEDA fed into the extruder. Table 1 lists the amounts of TMSPEDA and PE-HEMA used in addition to the melting temperatures (Tm), β-transition temperature (Tβ), and degrees of crystallinity (Xcr) of the resulting vitrimers.

TABLE 1

| | | | | Maximal | | | |
|---|---|---|---|---|---|---|---|
| | PE- | | | reacted | | | |
| | HEMA | TMSPEDA | | —OH^{b} | Tₘ^{c} | T_{β}^{d} | X_{cr}^{e} |
| Polymer | [g] | [g] | X/C^{a} | [%] | [° C.] | [° C.] | [%] |
| PE- | — | 0 | 0 | 0 | 73.9 | −6.5 | 12.2 |
| HEMA | | | | | | | |
| Vitrimer 1 | 10 | 0.66 | 3 | 34.7 | 72.4 | −4.9 | 11.7 |
| Vitrimer 2 | 10 | 0.88 | 4 | 46.3 | 72.1 | −4.4 | 12.0 |
| Vitrimer 3 | 8 | 1.06 | 6 | 69.5 | 71.0 | −4.0 | 10.9 |
| Vitrimer 4 | 7 | 1.39 | 9 | 104.2 | 69.7 | −1.9 | 10.7 |

^{a}Theoretical number of crosslinks per chain (X/C) was calculated using Mₙ of PE-HEMA and the amount of TMSPEDA used assuming that all 6 methoxy groups of TMSPEDA can undergo the reaction with PE-HEMA hydroxy groups.
^{b}Maximal % of reacted hydroxy groups was calculated from the mol ratio of HEMA and TMSPEDA assuming that all 6 methoxy groups of TMSPEDA can undergo the reaction with PE-HEMA hydroxy groups.
^{c}Melting temperatures (Tₘ) were determined by DSC from the second heating scan.
^{d}β transition temperatures (T_{β}) were determined by DMTA from the maximum of tan δ.
^{e}Degrees of crystallinity (X_{cr}) were calculated dividing the melting enthalpy of 100% crystalline PE (286.2 J/g) (See, Wunderlich et al., “Heat of fusion of polyethylene”, J. Polym. Sci., Part A-2: Polym. Phys. 1967, 5 (5), 987-988) by melting enthalpy of a vitrimer determined by DSC from the second heating scan.

As illustrated in Table 1, the crystallinity X_{cr} is >10% for all four vitrimers. Notably, introduction of the TMSPEDA crosslinker does not substantially alter the crystallinity of the resulting vitrimer compared with the crystallinity of the PE-HEMA. The semi-crystallinity of the vitrimer polymers can be advantageous, as it can impart increased strength due to the presence of crystalline domains. Therefore, the need of extra network formation coming from the dynamic crosslinker for the inventive compositions is reduced compared to amorphous polymers, as both networks (crystallinity and dynamic crosslink) will be combined in the material of the present invention at typical use temperatures resulting in an enhanced mechanical profile and chemical resistance. Further, the processability of the semi-crystalline vitrimers is improved when compared with amorphous vitrimers such as those described by Nishimura et al. (Journal of the American Chemical Society, 2017, 139, 14881-14884). In particular, and in some aspects, the semi-crystalline vitrimers of the present invention can have a relatively low melting point (Tm) (e.g., around 60° C. to 80° C., or around 70° C.). This allows for the above-mentioned extrusion processing conditions in which the vitrimers can be produced via extrusion at 120° C. to 180° C. in about 1 to 15 minutes. By comparison, Nishimura et al. concerns a fully amorphous polystyrene-based vitrimer polymer, which was produced via compression-mold for 6 hours at 160° C. Without wishing to be bound by theory, it is believed that the Nishimura et al. polymer has a glass transition temperature (Tg) of ˜100° C. pre-cross-linking. Therefore, it is believed that Nishimura et al.'s vitrimer could not be produced using an extruder because their material would not have acceptable flow characteristics unless a temperature of >200° C. is used (which is the average of conventional melt temperature of non-crosslinked polystyrene, according to WO 2017/035180); however, such a high temperature could jeopardize the stability of the crosslinker, as the alkoxysilane would be prone to hydrolysis and condensation reactions (B. Arkles et al., Silanes and other coupling agents, Ed. K. L. Mittal 1992, pp. 91-104), and the secondary amine would be prone to oxidation degradation reactions.

The following equation (equation 1) was used to determine the X/C value in Table 1.

$$\text{X/chain} = \frac{{M}_{n} [ \frac{g}{mol} ] \cdot HEMA [ mol \% ] \cdot reacted OH [ \% ]}{\begin{matrix}HEM A [ mol \% ] \cdot {M}_{H E M A} [ \frac{g}{mol} ] + \\ ( 100 - H E M A [ mol \% ] ) \cdot {M}_{e t h y l e n e} [ \frac{g}{mol} ]\end{matrix}} \qquad ( 1 )$$

### Example 2

### Characterization of Vitrimers of the Present Invention

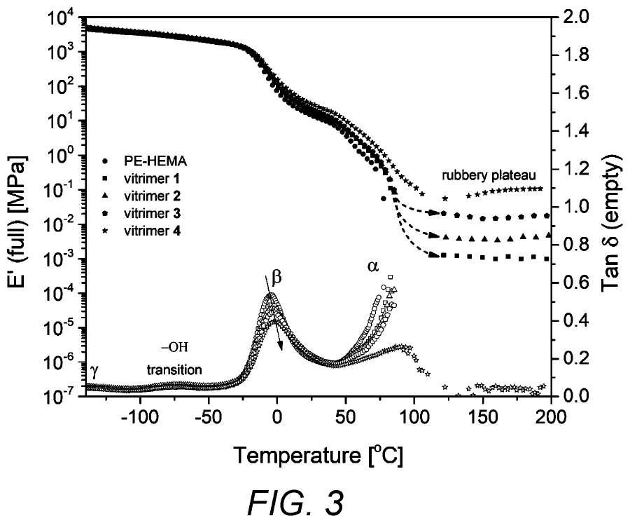

Rheology. DMTA revealed that, upon gradual heating, PE-HEMA and vitrimers 1-4 underwent a transitions corresponding to melting of the crystalline phase. While PE-HEMA flowed after the melting transition, vitrimers 1-4 displayed rubbery plateaus with low modulus instead, characteristic of crosslinked materials which gave also another indication about improved melt strength of such materials. For instance, the plateau modulus of vitrimer 4 was around 0.1 MPa, however, for softer vitrimers 1-3 with lower crosslink densities, plateau modulus recordings had to be adapted from temperature sweeps measurements (FIG. 3).

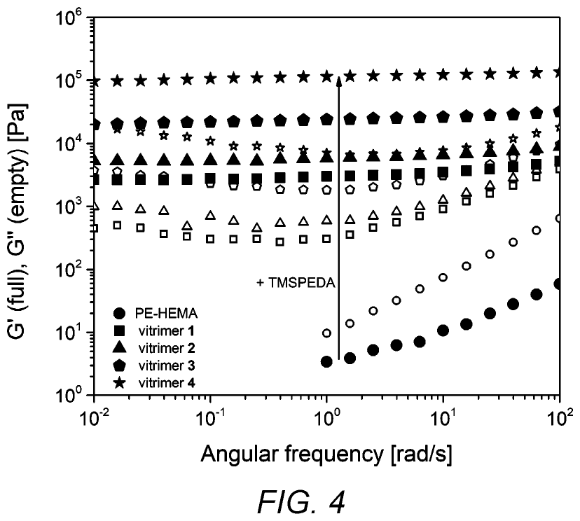

Referring to FIG. 4, PE-HEMA displayed a typical behavior of a low molecular weight polymer melt with a strong frequency dependence. No crossover point between storage (G′) modulus (filled monikers designated as full) and loss (G″) modulus (unfilled monikers designated as empty) was observed and the polymer was more viscous (G″ higher than G′) than elastic (G′ higher than G″) within the whole studied frequency range. Moreover, PE-HEMA flowed out from between the plates of the rheometer at lower frequencies demonstrating a very low viscosity. After dynamic crosslinking with TMSPEDA, vitrimers 1-4 behaved like an elastic solid with frequency independent G′ and much lower G″ which is characteristic of crosslinked materials.

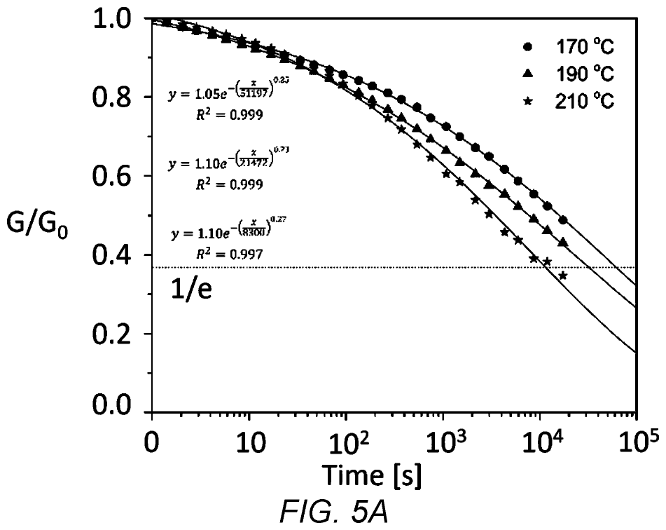

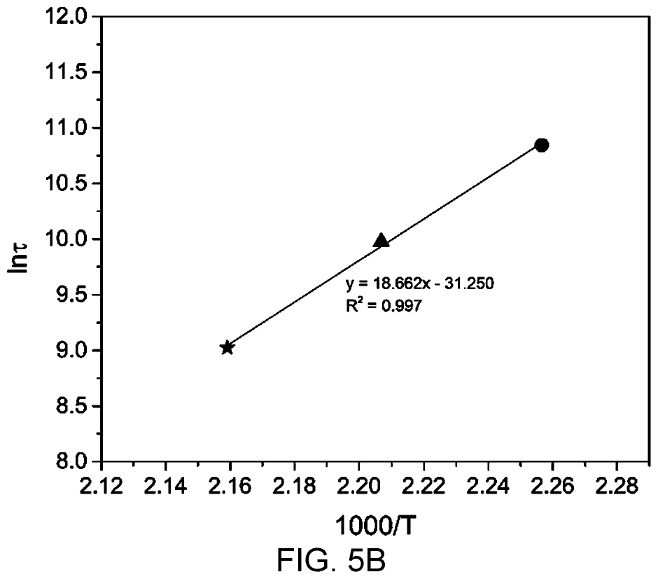

Although the vitrimers 1-4 were cross-linked, they were able to relax stresses at elevated temperatures, indicating that the network is indeed dynamic (FIG. 5). The relaxation was significantly shifted toward shorter time-scales upon increasing temperature, which proved that the exchange reactions speed up with temperature making processing possible.

Stress relaxation curves of vitrimer 2 have a typical shape characteristic for vitrimers where stress relaxation is governed by the exchange reactions (FIG. 5A) (Tellers et al., Polym. Chem. 2019, 10 (40), 5534-5542). The experimental data did not fit well to the Maxwell model and were fitted using a modified Maxwell equation (equation 2) with an exponent a (Séréro et. al., Macromolecules 2000, 33 (5), 1841-1847).

$$G ( t ) = {G}_{o} {e}^{- {( \frac{t}{τ} )}^{a}} \qquad ( 2 )$$

The exponent a represent a deviation from Maxwell law (a=1) caused by different crosslinks with unequal strengths. In present case a ˜0.25 which can be attributed to the presence of chain entanglements, trapped loops of the polymer backbone, and hydrogen bonding between the hydroxy groups of HEMA besides the silyl ether crosslinks (Meng et. al., Macromolecules, 2016, 49 (7), 2843-2852; Hotta et al., Macromolecules, 2002, 35 (1), 271-277). Based on the stress relaxation, activation energy of the topological rearrangement (Eₐ) and topology-freezing transition temperature (Tᵥ) were determined using Arrhenius plot of the relaxation times (FIG. 5B). Eₐ of 155 kJ/mol and Tᵥ of 87° C. were calculated, which is much higher than the ones of the polystyrene based system (Eₐ=81 kJ/mol, Tᵥ=47° C.) reported previously (Nishimura et. Al., J. Am. Chem. Soc. 2017, 139 (42), 14881-14884) and is also reflected in longer relaxation times which might be cause by the use of different polymer matrix and unequal crosslink density (Séréro et. al., Macromolecules 2000, 33 (5), 1841-1847). Tᵥ of vitrimer 2 is just few degrees higher than its melting point (˜72° C.) facilitating processability at relatively low temperatures.

Calculation of activation energy (Eₐ) of vitrimer 2: Topology-freezing transition temperatures (Tᵥ) and activation energies (Eₐ) were determined using the methodology reported in literature (Nishimura et. Al., J. Am. Chem. Soc. 2017, 139 (42), 14881-14884; Capelot et. al., ACS Macro Lett. 2012, 1 (7), 789-792; Brutman et al., ACS Macro Lett., 2014, 3 (7), 607-610). The measured values of relaxation time τ were plotted versus 1000/T. The plot was fitted to the Arrhenius law in equation (3) (FIG. 5B).

$$τ = {τ}_{0} {e}^{\frac{{E}_{a}}{R T}} \qquad ( 3 )$$

R—universal gas constant; 8.31 J/(K·mol), Eₐ—activation energy, T—temperature

Equation (3) can be transformed to equation (4) of a linear function y=ax+b:

$$ln τ = \frac{{E}_{a}}{R T} + {ln τ}_{0} = a \frac{1000}{T} + b \qquad ( 4 )$$

Therefore Eₐ can be determined from the slope of the data in FIG. 5B according to the equation (5)

Eₐ=aR=155 kJ/mol (5)

Calculation of topology-freezing transition temperature (Tᵥ) of vitrimer 2: Tᵥ is defined to be the temperature at which the material reaches a viscosity of 10¹² Pa. The relation between the viscosity η and the characteristic relaxation time τ* can be calculated from the Maxwell relation equation (6).

$$η = G τ = \frac{{E}^{′} τ}{2 ( 1 + v )} \qquad ( 6 )$$

G—shear modulus, E′—plateau modulus (3500 Pa for vitrimer 2), v—Poisson's ratio (for PE v=0.469) (Ladizesky et. al., Journal of Macromolecular Science, Part B 2006, 5 (4), 661-692).

Using the equation (3), equation (5) and FIG. 5B, Tv can be calculated from equation (7).

$${T}_{v} = \frac{1000 a}{ln \frac{2 η ( 1 + v )}{{E}^{′}} - b} = 8 {7}^{∘} C . \qquad ( 7 )$$

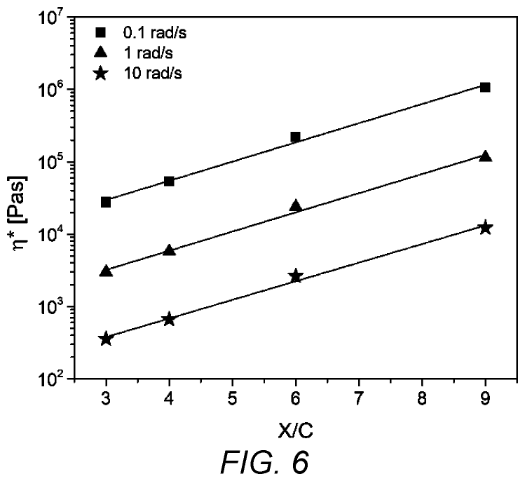

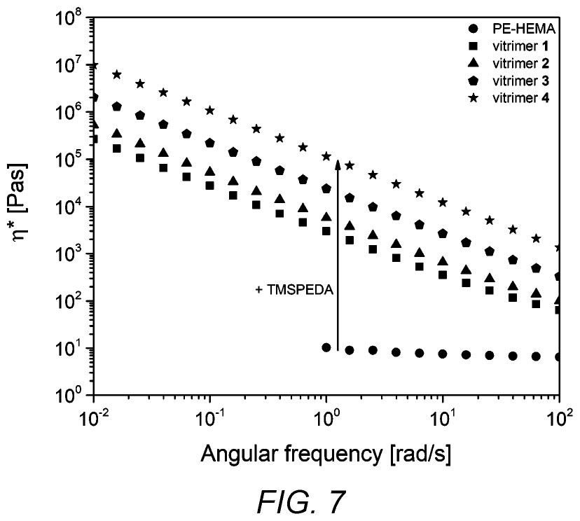

PE vitrimers displayed linear increase of complex viscosity with crosslink density at various frequencies as well (FIG. 6). While PE-HEMA reached the zero-shear viscosity at around 10 Pa, vitrimers 1-4 had viscosities a few orders of magnitude higher before they even reached their zero shear viscosities (FIG. 7). This result indicated highly improved melt strength which is extremely important for processes like film blowing, blow molding, thermoforming and foaming.

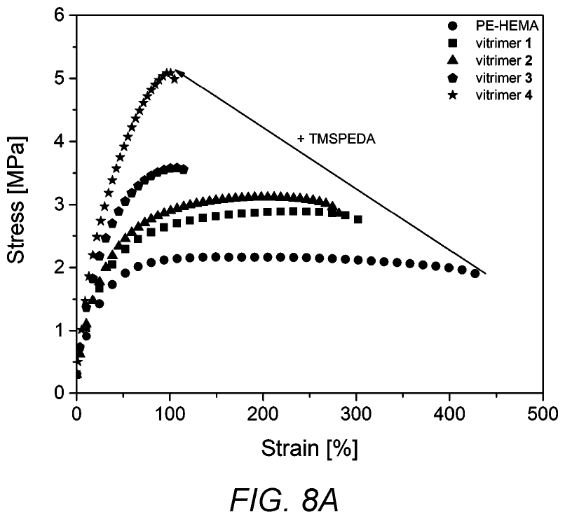

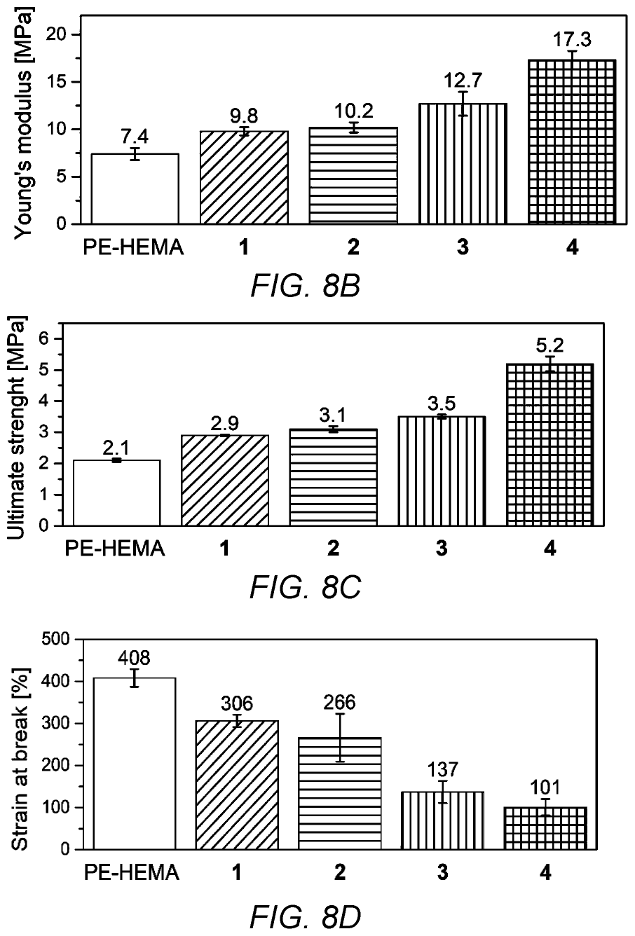

Mechanical properties. PE-HEMA exhibited tensile properties characteristic of a semi-crystalline thermoplastic, displaying an initial elastic deformation before the neck was formed followed by cold drawing and fracture (FIG. 8). Since PE-HEMA had a low molecular weight and a low crystallinity, low ultimate strength (2.1 MPa) and Young's modulus (7.4 MPa) were observed. By adding a specific amount of TMSPEDA crosslinker, it was possible to tune tensile properties of PE-HEMA making use of the dynamic crosslinking behavior. As expected, increasing amount of TMSPEDA gradually improved ultimate strength (up to 134%) and Young's modulus (up to 148%).

All prepared vitrimers were insoluble in xylene at 100° C. for 24 h demonstrating crosslinked character and excellent solvent resistance while PE-HEMA dissolved completely under the same conditions. Table 2 lists the gel fraction of PE-HEMA and vitrimers 1-4.

TABLE 2

| | Maximal | Before | After | Gel fraction |
|---|---|---|---|---|
| Polymer | X/C^{a} | [g] | [g] | [%] |
| PE-HEMA | 0 | 0.224 | 0 | 0 |
| vitrimer 1 | 3 | 0.208 | 0.039 | 19 |
| vitrimer 2 | 4 | 0.242 | 0.061 | 25 |
| vitrimer 3 | 6 | 0.242 | 0.068 | 28 |
| vitrimer 4 | 9 | 0.248 | 0.1 | 40 |

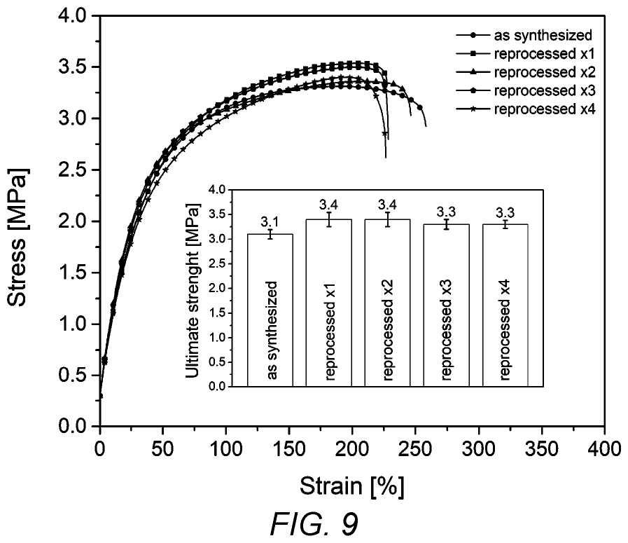

Despite the crosslink nature, dynamic silyl ether exchange enabled processability and recyclability of this system using industrial relevant techniques like injection and compression molding. Even after reprocessing for 4 times, no decrease in mechanical performance was observed (FIG. 9) showcasing robustness of TMSPEDA crosslinks.

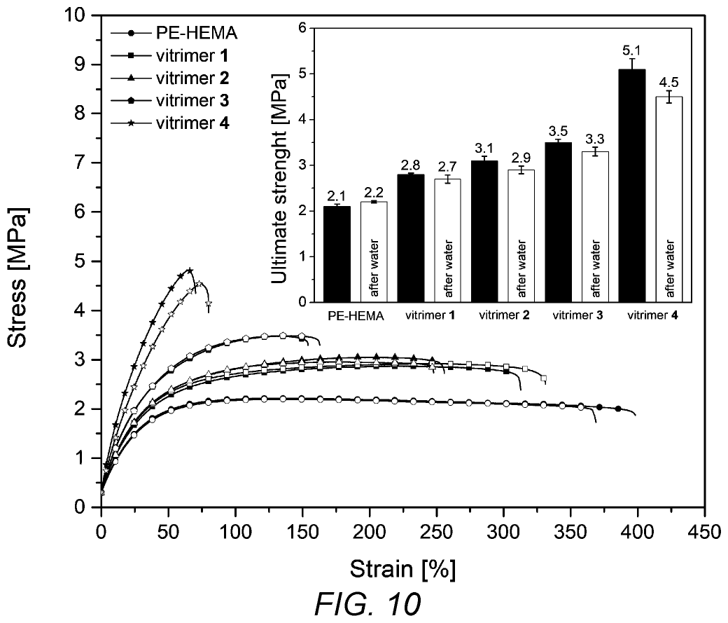

Since silyl ethers can be prone to hydrolysis, therefore, hydrolytic stability of PE-TMSPEDA was assessed by exposing specimens to water for 24 h at room temperature and subsequently measuring water uptake, gel fraction and tensile properties. All vitrimers showed minimal water uptake of less than 1% and the gel fraction (Table 3) as well as tensile properties (FIG. 10) were not significantly affected by exposure to water. In general, hydrophobic nature of the polymer backbone prohibits swelling and water uptake into the cross-linked network, protecting silyl ethers from hydrolysis which is of great importance for industrial applications like water pipes and electrical cables isolation.

TABLE 3

| | | | | Gel | Gel fraction |
|---|---|---|---|---|---|
| | Maximal | Before | After | fraction | as synthesized |
| Polymer | X/C^{a} | [g] | [g] | [%] | [%] |
| PE-HEMA | 0 | 0.262 | 0 | 0 | 0 |
| vitrimer 1 | 3 | 0.226 | 0.043 | 19 | 19 |
| vitrimer 2 | 4 | 0.24 | 0.061 | 25 | 25 |
| vitrimer 3 | 6 | 0.241 | 0.07 | 29 | 28 |
| vitrimer 4 | 9 | 0.253 | 0.104 | 41 | 40 |

Hot set (creep) test: Hot set test was performed using dumbbell-shaped samples with an initial length of L₀=20 mm and thickness of 0.5 mm. The samples were allowed to creep for 10 min at 200° C. by applying a weight of 0.5 g. The final length Lₕₒₜ was measured to calculate the hot set elongation εₕₒₜ=(Lₕₒₜ−L₀)/L₀.

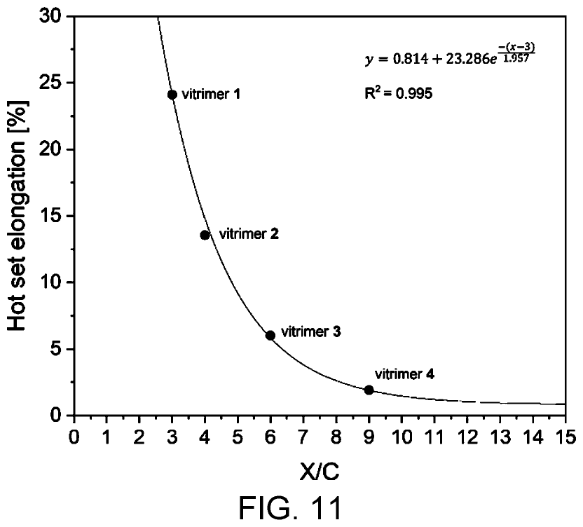

Dynamic silyl ether crosslinking of PE-HEMA greatly improved dimensional stability at elevated temperatures and decreased creep in an exponential fashion with TMSPEDA amount as revealed by the hot set test. While the hot set elongation of vitrimer samples after 10 min at 200° C. under 0.5g load were fairly low (below 30%), PE-HEMA completely melted and failed almost immediately. FIG. 11 shows hot set elongation of vitrimers 1-4. Fit through the curve has the equation y=0.814+23.286e\hat{ }(−(x−3)/1.957) and R²=0.995.

Although embodiments of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein can be utilized. Accordingly, the appended claims are intended to include within their scope such processes, machines, manufacture, compositions of matter, means, methods, or steps.

1. A semi-crystalline vitrimer polymer composition comprising: 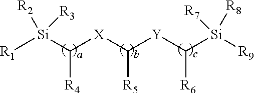
wherein:
R₁ and R₉ are each independently a hydroxyl-functionalized polymeric group;
R₂, R₃, R₇, and R₈ are each independently a hydroxyl-functionalized polymeric group, an aliphatic group, a hydroxy group (OH), or an alkoxy group;
R₄, R₅, and R₆ are each independently H or an aliphatic group;
X and Y are each independently NH, O, S, or CH₂; and
a is 1 to 10, b is 1 to 10, and c is 1 to 10;
wherein R₁ and R₉ are each: 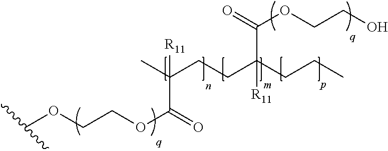
wherein R₁₁ is H or an alkyl group, q is 1 to 10, m is >0, n+m=0.01 to 0.2, p is 0.8 to 0.99, and the monomer units corresponding to n, m, andp are randomly distributed.

2. The semi-crystalline vitrimer polymer composition of claim 1, wherein R₂, R₃, R₇, and R₈ are each independently a polyolefin hydroxyl-functionalized polymeric group, a polycarbonate hydroxyl-functionalized polymeric group, or a polyester hydroxyl functionalized polymeric group.

3. The semi-crystalline vitrimer polymer composition of claim 2, wherein R₂, R₃, R₇, and R₈ are each independently a polyolefin hydroxyl-functionalized polymeric group.

4. The semi-crystalline vitrimer polymer composition of claim 1, wherein R₁, R₂, R₃, R₇, R₈ and R₉, are each: 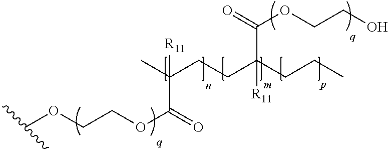
wherein R₁₁ is H or an alkyl group, q is 1 to 10, m is >0, n+m=0.01 to 0.2, p is 0.8 to 0.99, and the monomer units corresponding to n, m, andp are randomly distributed.

5. The semi-crystalline vitrimer polymer composition of 1, wherein R₂, R₃, R₇, and R₈, are each: 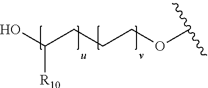
where R₁₀ is H or an alkyl, u is 0 to 1, v is 0 to 1, u+v=1 and the monomer units corresponding to u and v are randomly distributed.

6. The semi-crystalline vitrimer polymer composition of 1, wherein R₂, R₃, R₇, and R₈, are each: 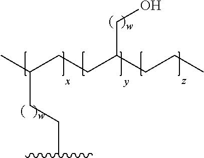
where y is >0, x+y=0.01 to 0.2, z is 0.8 to 0.99, x+y+z=1w is 0 to 20, and the monomer units corresponding to x, y, and z are randomly distributed.

7. The semi-crystalline vitrimer polymer composition of 1, wherein R₂, R₃, R₇, and R₈, are each: 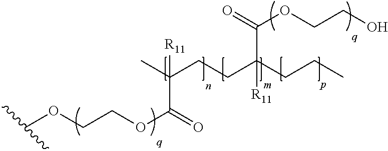
where R₁₁ is H or an alkyl group, q is 1 to 10, m is >0, n+m=0.01 to 0.2,p is 0.8 to 0.99, and the monomer units corresponding to n, m, and p are randomly distributed.

8. The semi-crystalline vitrimer polymer composition of claim 1, wherein X and Y are NH, a and c are 2 to 4, and b is 1 to 3, and R₁, R₂, R₃, R₇, R₈ and R₉ are each: 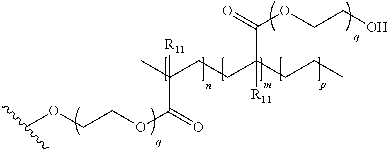
where R₁₁ is H or an alkyl group, q is 1 to 10, m is >0, n+m=0.01 to 0.2, p is 0.8 to 0.99, n+m+p=1, and the monomer units corresponding to q, n, m, and p are randomly distributed.

9. The semi-crystalline vitrimer polymer composition of claim 8, having the structure of: 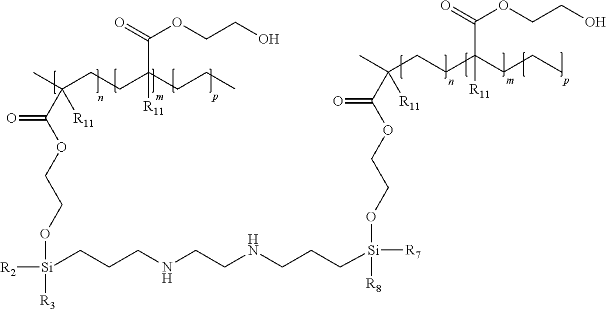
where m is >0, n+m=0.01 to 0.2, p is 0.8 to 0.99, and the monomer units corresponding to q, n, m, andp are randomly distributed.

10. The semi-crystalline vitrimer polymer composition of claim 1, wherein the vitrimer composition has a degree of crystallinity of 5% to 40%.

11. The semi-crystalline vitrimer polymer composition of claim 10, wherein the vitrimer composition has a degree of crystallinity of 7% to 15%.

12. A method of making a semi-crystalline vitrimer polymer composition comprising extruding a silyl (Si) ether crosslinking agent with a hydroxyl (OH)-functionalized polymer;
wherein the hydroxyl-functionalized polymer has the structure of: 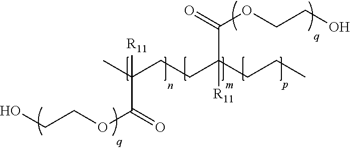
where R₁₁ is H or an alkyl group, q is 1 to 10, m is >0, n+m=0.01 to 0.2,p is 0.8 to 0.99, n+m+p=1, and the monomer units corresponding to n, m, and p are randomly distributed.

13. The method of claim 12, wherein extruding comprises adding the silyl ether crosslinking agent in the absence of a solvent to the hydroxyl functionalized polymer, a temperature of from 110° C. to 300° C. or both.

14. The method of claim 12, wherein extruding comprises adding the silyl ether crosslinking agent in the absence of a solvent to the hydroxyl functionalized polymer, a temperature of from 120° C. to 180° C.

15. The method of claim 12, wherein extruding comprises adding the silyl ether crosslinking agent in the absence of a solvent to the hydroxyl functionalized polymer, a temperature of 300° C.

16. The method of claim 12, wherein extruding comprises adding the silyl ether crosslinking agent in the absence of a solvent to the hydroxyl functionalized polymer, a temperature of 180° C.

17. The method of claim 12, wherein R₁₁ is H.

18. The method of claim 12, wherein the number of OH groups from the hydroxyl functionalized polymeric group to the number OH or alkoxy groups on the silicon atom of the silyl ether crossing agent is greater than 1:1.

19. The method of claim 12, wherein extruding comprises adding the silyl ether crosslinking agent in the absence of a solvent to the hydroxyl functionalized polymer, a temperature of from 110° C. to 300° C.

20. An article of manufacture comprising the semi-crystalline vitrimer polymer composition of claim 1.
